(19) United States
(12) Patent Application Publication
(10) Pub. No.: US 2014/0188539 A1
(43) Pub. Date: Jul. 3, 2014

(54) SNS BASED AUTO SCHEDULE MANAGEMENT SERVICE SYSTEM

(71) Applicant: KAIST (Korea Advanced Institute of Science and Technology), Daejeon (KR)

(72) Inventors: Key Sun CHOI, Daejeon (KR); Youngun YUN, Daejeon (KR); Young Gyun HAHM, Daejeon (KR); Kyung Tae LIM, Daejeon (KR)

(73) Assignee: KAIST (Korea Advanced Institute of Science and Technology), Daejeon (KR)

(21) Appl. No.: 13/965,969

(22) Filed: Aug. 13, 2013

(30) Foreign Application Priority Data
Dec. 31, 2012 (KR) 10-2012-0158586

(51) Int. Cl. G06Q 50/00; G06Q 10/10

(52) U.S. Cl. CPC G06Q 50/01; G06Q 10/1095
USPC 705/7.19

(57) ABSTRACT

Disclosed is an SNS based auto schedule management service system that detects and extracts event information from SNS messages and records corresponding events in a personal schedule management system.

### BACKGROUND OF THE INVENTION

1. Field of the Invention

The present invention relates, in general, to an SNS based auto schedule management service system, and, more particularly, to an SNS based auto schedule management service system that detects and extracts event information from SNS messages and records corresponding events in a personal schedule management system.

2. Description of the Belated Art

In today's modern world, people use various social network services (SNS). SNS refers to a service which allows a user to interact with various persons online. Users can make new personal connections or can strengthen established personal connections through the SNS. Currently, representative SNS sites are Facebook, Twitter and Kakao Talk.

Generally, to manage his or her personal and business schedules, the user records and stores the schedules in a computer and then frequently checks the schedules, or uses a method which records information regarding his or her schedules on a calendar provided by a specific site (e.g. Google).

The schedule management service is a method of recording the user's schedules and necessary memos in a diary program wherein the data can be maintained and checked by the user, and such a service is often described as a web diary, an internet diary, a cyber diary or an electronic calendar. As various convenient functions therefor are provided, a penetration rate of schedule management services is rapidly increasing.

As described above, the conventional schedule management service technology is problematic in that each function for the schedule management service should be separately performed, and that the user is required to remember his or her schedules and is required to separately input information for updating the schedules.

### SUMMARY OF THE INVENTION

Accordingly, the present invention is intended to propose a schedule management service system capable of providing a service for automatically extracting information relating to the user's schedules and events and providing the information to the user, thereby providing a method of reliably storing certain information that the user is easy to miss among messages transmitted from SNS and the like.

In order to achieve the above object, according to one aspect of the present invention, there is provided a schedule management service system, comprising: a means for collecting data from an SNS; a means for collecting GPS information, time information, and other event information; a means for extracting time information, a place, a person, a subject and detailed contents from SNS messages through natural language treatment; a means for recognizing events from information shown through the SNS and the natural language treatment and specifying the respective events into a domain; and a means for classifying the events according to the passage of time and updating the classified events in a time-table form in the schedule management system.

An effect of the schedule management system according to the present invention is that, because user information and schedule management information axe automatically extracted from various SNS sites on the Internet and from message contents, and the information is stored, even though the user does not directly record information regarding his or her schedules, the user can automatically access and view the information.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram schematically showing a schedule management service system according to the present invention; and

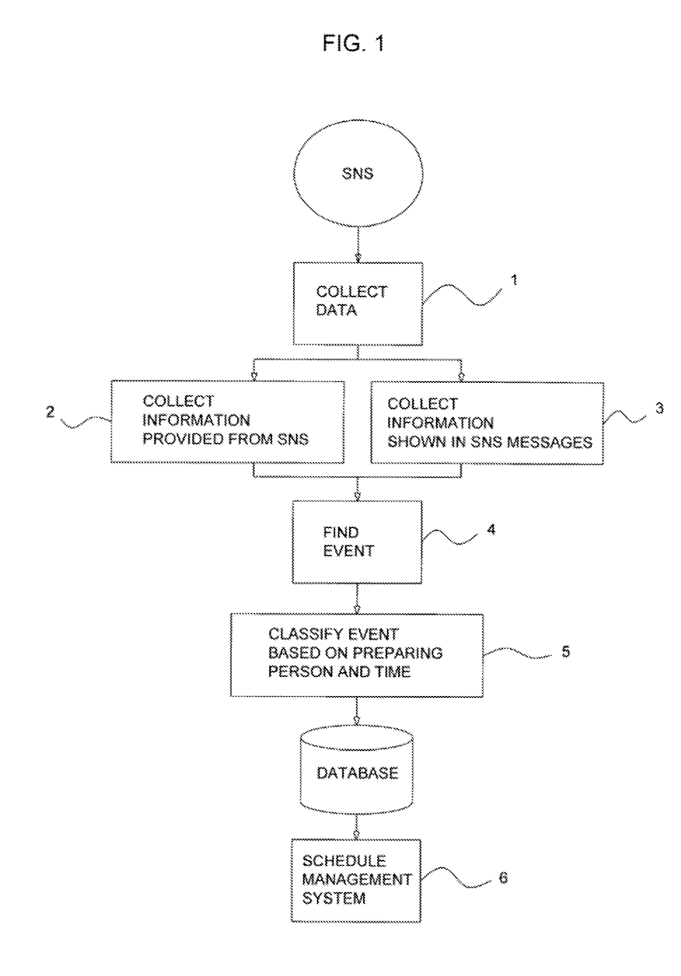

FIG. 2 is a block diagram showing a part of the configuration of a client's server in which modules for collecting data from each SNS are mounted.

### DETAILED DESCRIPTION OF THE INVENTION

Hereinbelow, preferred embodiments of the present invention will be described in detail with reference to the accompanying drawings.

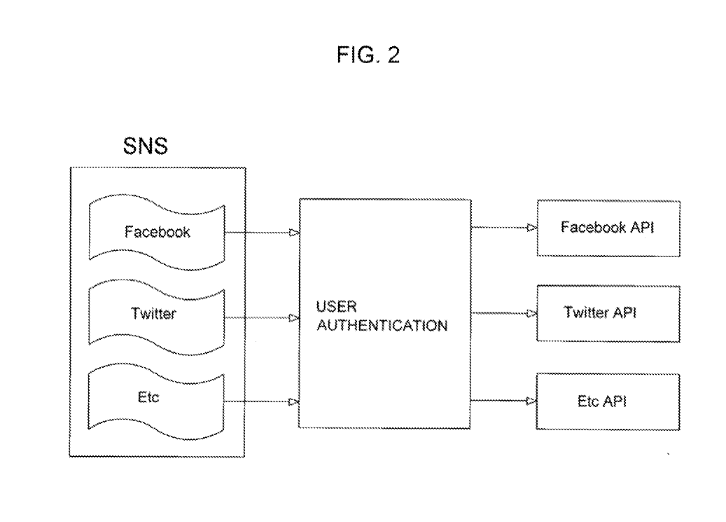

Modules, which are means for collecting data from each SNS, namely, means for performing user authentication by connecting to each SNS, as shown in FIG. 2, and obtaining authority to collect the data, and which correspond to each SNS, are mounted in a client's server.

The client's server comprises a means for collecting GPS information, time information and other event information from the collected data. The other event information may include a photo imagery, a video, a web pay link and the like, as well as contents such as a list of persons to attend a conference, a conference place, and the like.

Time information, a place, a person, a subject and detailed contents are extracted from the SNS messages through the natural language treatment.

Events are recognized from the information shown through the SNS and the natural language treatment, and the respective events are specified into a domain.

The events are classified according to the passage of time, and the classified events are updated in a time-table form in the schedule management system.

What is claimed is:

1. An SIMS based auto schedule management service system, the system comprising:
means for collecting data from an SNS;
means for collecting GPS information, time information, and other event information from collected data;
means for extracting time information, a place, a person, a subject and detailed contents from SNS messages through natural language treatment;
means for recognizing events from information shown through the SNS and the natural language treatment and specifying respective events info a domain; and
means for classifying the events depending on passage of time and up-dating the classified events in a time-table form in a schedule management system,

2. The system according to claim 1, wherein the means for collecting the data from the SNS comprises nodules corresponding to each SNS.

3. The system according to claim 1, wherein when updating the classified events in the time-table form in the schedule management system, a domain is established depending on a size of iCal, which is Apple's schedule management program.
